(19) United States
(12) Patent Application Publication
(10) Pub. No.: US 2012/0175859 A1
(43) Pub. Date: Jul. 12, 2012

(54) VEHICLE TOWING ASSEMBLY

(75) Inventor: Calvin W. ROTH, JR., Newville, PA (US)

(73) Assignee: LIFT & TOW, LLC, Shippensburg, PA (US)

(21) Appl. No.: 12/986,337

(22) Filed: Jan. 7, 2011

(51) Int. Cl. B60D 1/54; B23P 11/00

(52) U.S. Cl. 280/491.4; 280/491.1; 29/428

(57) ABSTRACT

A tow vehicle and tow assembly are disclosed that conceals the tow assembly underneath the tow vehicle.

### FIELD OF THE INVENTION

The present invention is generally directed to vehicle towing, and in particular, to a towing assembly that can be mounted underneath an existing vehicle.

### BACKGROUND OF THE INVENTION

Tow trucks were developed that generally include a crane and a hook or sling for engaging a front or rear frame or bumper portion of a vehicle to be towed. However, these tow trucks may be ineffective at safely and reliably towing newer model vehicles, due to lower chassis heights, new bumper designs and air-dams.

To overcome these limitations, tow trucks for towing vehicles were developed to lift the front or rear wheels of the towed vehicle off the ground and towing the partially-lifted automobile on its remaining wheels. These tow trucks have been generally referred to as “wheel-lift” tow trucks. Wheel-lift tow trucks generally employ a telescoping or folding main crane or boom attached to the rear of a truck specifically designed to receive the boom. The boom is mounted on a rear deck portion of the wheel-lift tow truck. The boom generally extends rearward from and out beyond the truck's rear deck (the space between the rear of the truck cab and the rear bumper). The boom is the main lifting or leverage component for lifting one end of the vehicle to be towed. These wheel-lift tow trucks also generally utilize a wheel engaging apparatus, hereinafter referred to as a wheel grid, for engaging and holding the front or rear wheels of the towed vehicle. The wheel grid typically includes a fixed cross arm or wheel boom attached to an end of the main boom, and wheel retainers for engaging the wheels of the vehicle to be towed.

The prior art tow trucks are expensive, conspicuous and generally unusable for purposes other than towing. In particular, when vehicles are to be repossessed and removed from a location by towing, it is desirable that the approach and engagement of the tow truck and the vehicle to be towed be as inconspicuous as possible.

Thus, a long felt need exits to provide a towing apparatus that can be assembled to a conventional pickup truck vehicle to provide an inconspicuous approach for towing operations.

### SUMMARY OF THE INVENTION

A first aspect of the disclosure includes a tow assembly including a mounting frame, and a wheel lift assembly. The wheel lift assembly includes a boom assembly, and a wheel lift assembly. The wheel lift assembly is configured to be substantially concealed beneath a footprint of a tow vehicle to which the tow assembly is attached.

A second aspect of the disclosure includes a tow vehicle including a vehicle having a vertical footprint and tow assembly attached underneath the vehicle. The tow assembly includes a mounting frame, and a wheel lift assembly. The wheel lift assembly includes a boom assembly, and a wheel lift assembly. The wheel lift assembly is configured to be substantially concealed beneath the vertical footprint of the vehicle.

A third aspect of the disclosure includes a method of installing a tow assembly to a vehicle including providing a vehicle having a vertical footprint, and attaching a tow assembly underneath the vehicle. The tow assembly is more than 95% concealed beneath the footprint of the vehicle.

One advantage of the present disclosure is to provide a towing apparatus kit that can be assembled to a conventional pickup truck vehicle.

Another advantage of the present disclosure is to provide a towing apparatus that is assembled substantially underneath a conventional pickup truck vehicle body.

Another advantage of the present disclosure is to provide a towing apparatus that is retractable to be substantially underneath a conventional pickup truck body, leaving the tail gate and bed intact to maintain the truck's functionality.

Another advantage of the present disclosure is to provide a towing apparatus having a lifting point at the rear axle to maintain stability on the road while towing.

Another advantage of the present disclosure is to provide a towing apparatus with in cab controls that operate from a 12-volt power supply that allows for single person operation

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an embodiment of a towing vehicle according to the invention.

FIG. 1A is a perspective view of an embodiment of a tow assembly according to the invention.

FIG. 2 illustrates a partial bottom view of an embodiment of a towing system according to the invention.

FIG. 3 illustrates a perspective view of the extension component of the towing system of FIG. 2.

FIG. 4A illustrates a perspective view of the wheel grip assembly of the towing system of FIG. 2.

FIG. 4B illustrates a perspective view of the wheel grip assembly of

### DETAILED DESCRIPTION OF THE INVENTION

The present invention is generally directed to a tow assembly system that is mounted underneath a consumer vehicle. The unique under-body construction of the tow assembly is completely retractable, leaving the tail gate and bed of the support vehicle intact to maintain the truck's functionality. The lifting point is at the rear axle instead of the rear bumper, thus maintaining stability on the road while towing. The tow assembly includes a control system and hydraulics to operate the system. In an embodiment, the control system may include a wireless remote. The control system allows the tow assembly to power up or down while extending or retracting the tow assembly.

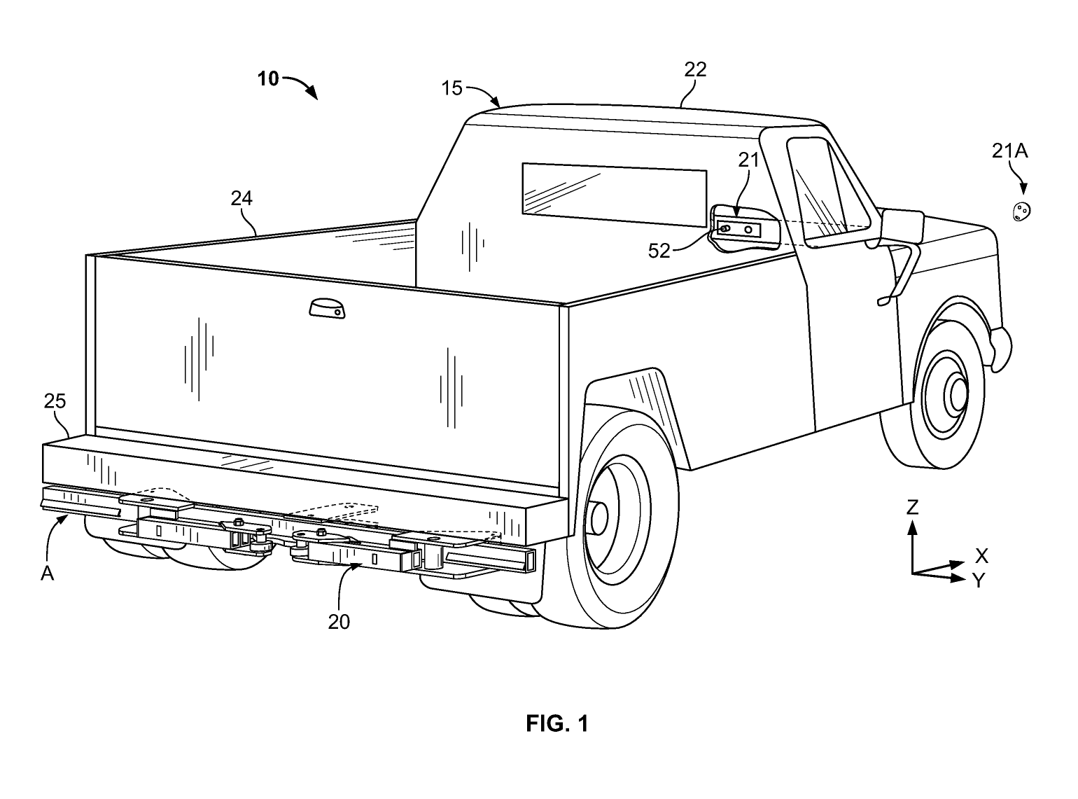

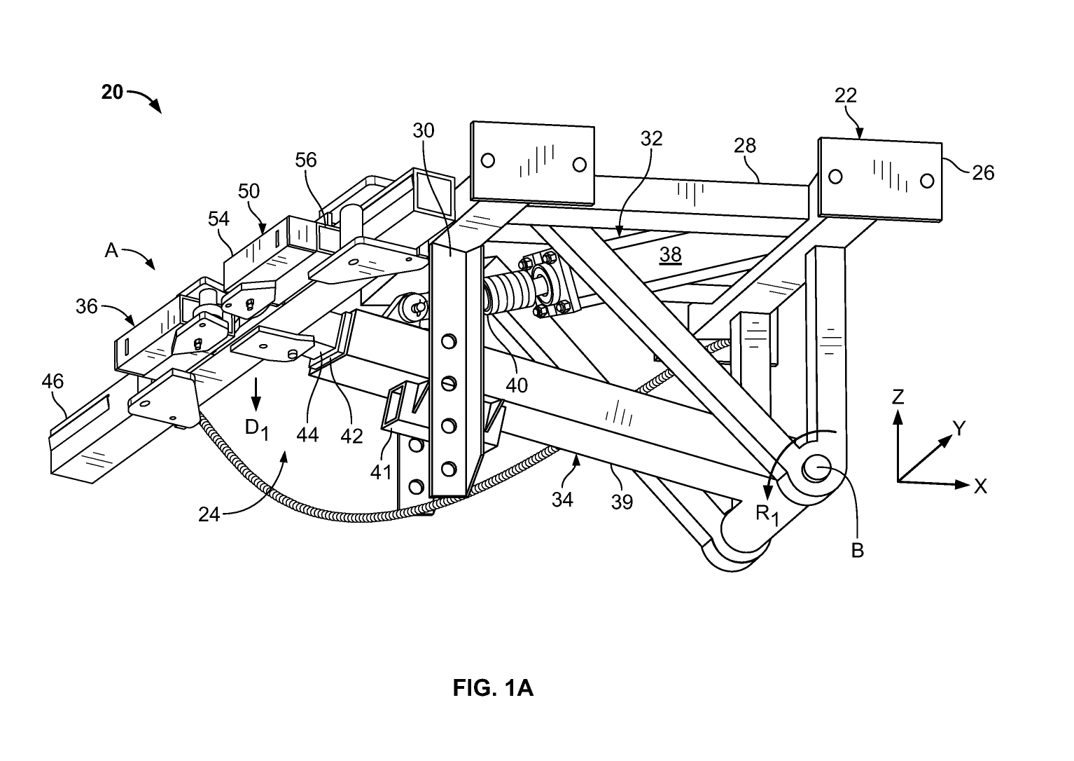

FIG. 1 illustrates an embodiment of a tow vehicle 10 according to the present invention. The tow vehicle 10 includes a vehicle 15 and a tow assembly 20. The vehicle 15 includes a cab 22, a bed 24 and a rear bumper 25. In this exemplary embodiment, the vehicle 15 is a pick-up truck. In another embodiment, the vehicle 15 may be another truck type, such as, but not limited to a flat-bed truck, a suburban utility vehicle (SUV), or other motorized vehicle having a towing capacity capable of towing another vehicle.

The tow assembly 20 is positioned or located below the bed 24 of the vehicle 15. In particular, the tow assembly 20 is shown in an initial, fully retracted, stored or stowed configuration A. As can be seen in FIG. 1, when in the stowed configuration A, the tow assembly 20 is substantially concealed underneath the footprint of the vehicle 15. In this disclosure, the term “substantially concealed underneath” means that the tow assembly 20 is more than 95% under the vertical footprint of the vehicle 15. In another embodiment, the tow assembly 20 is more than 98% under the vertical footprint of the vehicle 15. In yet another embodiment, 100% of the tow assembly 20 is underneath the vertical footprint of the vehicle 15.

FIG. 1A shows the tow assembly 20 removed from underneath the vehicle 15 (FIG. 1) and in a stowed position A. As can be seen in FIG. 1A, the tow assembly 20 includes a frame 22 and a lift assembly 24. The frame 22 includes mounting brackets 26 for attaching the tow assembly 20 to the vehicle 15 (FIG. 1). In an embodiment, the mounting brackets 26 may attach the tow assembly 20 to a frame (not shown) of the vehicle 15. The mounting brackets 26 may be attached to the vehicle 213 by fasteners, welding and/or by other metal attachment technique or method. The frame 22 further includes a plurality of braces 28 for supporting the lift assembly 24. The frame 22 also includes guide rails 30.

The lift assembly 24 includes a hydraulic assembly 32, a boom assembly 34 and a wheel lift assembly 36. The lift assembly further includes an optional hitch receiver 41. In another embodiment, the optional hitch receiver 41 may be omitted. The hydraulic assembly 32 includes a base 38 and an extension member 40. The base 38 pivotally attaches to the frame 22 at a first or attachment end (not shown). The extension member 40 extends from the base 38 and is pivotally attached to the boom assembly 34. In FIG. 1A, the extension member 40 is shown in a fully retracted configuration, or in other words, the extension member 40 is fully withdrawn into the base 38. The base 38 includes and is connected to hydraulics (not shown) for extending and retracting the extension member 40. Extending the extension member 40, rotates the boom assembly 34 in a rotational direction R₁ about pivot attachment B, lowering the wheel lift assembly 36 in a downward direction D₁. As the boom assembly 34 is rotated and lowered, the boom assembly 34 is stabilized in the Y direction by guide rails 30.

The boom assembly 34 includes a boom housing 39, a first boom extension member 42 and a second boom extension member 44. In another embodiment, the boom assembly 34 may include one or more boom extension members. The second boom member 44 is attached to the wheel lift assembly 36. The first and second boom extension members 42, 44 telescopingly extend from the boom housing 40. The first and second boom extension members 42, 44 are extended and retracted by hydraulics (not shown). In an embodiment, the hydraulics contained within the boom assembly 34. The first and second boom members 42, 44 extend to move the wheel lift assembly 36 in a generally rearward direction (−X) and away from the vehicle 15 (FIG. 1).

The wheel lift assembly 36 includes a wheel lift base member 46 and wheel lift supports 50. The wheel lift supports 50 include wheel brace members 54 and wheel extension members 56. The wheel brace members 54 and wheel extension members 56 are extended and retracted by hydraulics (not shown) from the wheel lift base member 46.

The tow assembly 20 further includes a control system 21 (FIG. 1). The control system 21 controls the hydraulics that operate the tow assembly 20. In this exemplary embodiment, the control system 21 includes an operator control switch 52 mounted in the vehicle 15. The operator control switch 52 controls a hydraulic system (not shown) that operates the various hydraulically actuated components of the tow assembly 20. In another embodiment, the control switch 52 may be mounted in or on the vehicle 15. In yet another embodiment, the control system 21 may include an optional remote control unit 21A, such as, but not limited to a key fob unit. In another embodiment, the tow assembly 20 may be controlled by only the remote control unit 21A.

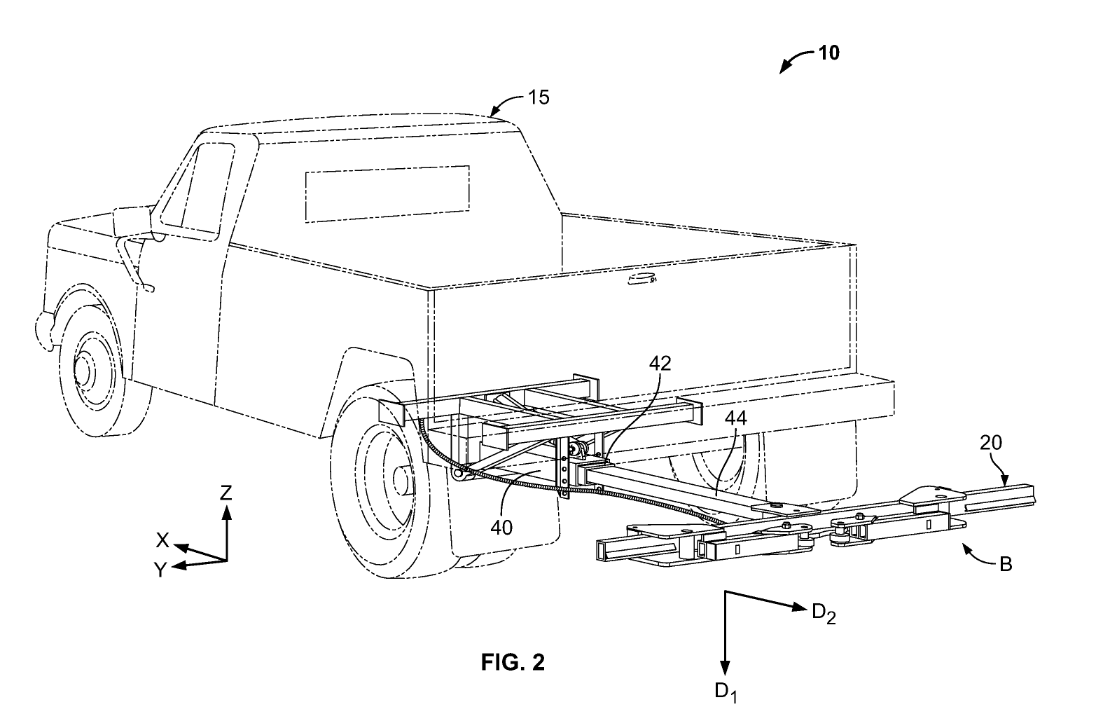

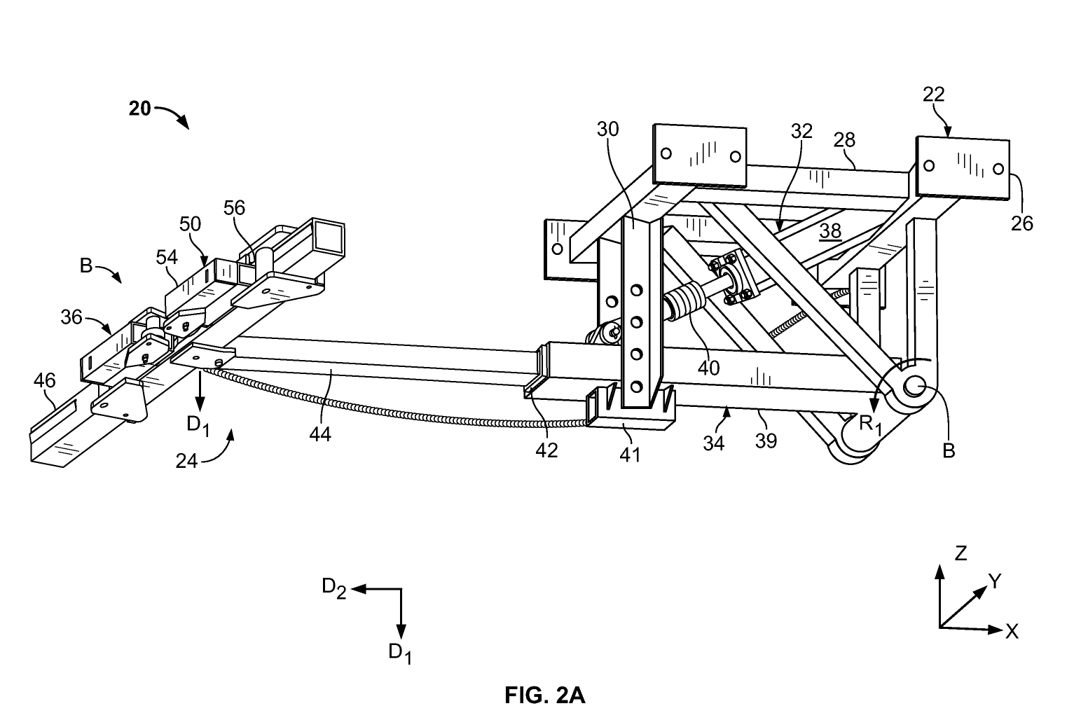

FIGS. 2 and 2A show the tow assembly 20 in a partially deployed configuration B. As can be seen in FIGS. 2 and 2A, the tow assembly 20 has been partially lowered in a downward direction D₁ and partially extended in a rearward direction D₂. The boom assembly 32 has been partially lowered in the downward direction D1, and the second boom extension member 46 has been fully extended from the first boom extension member 44.

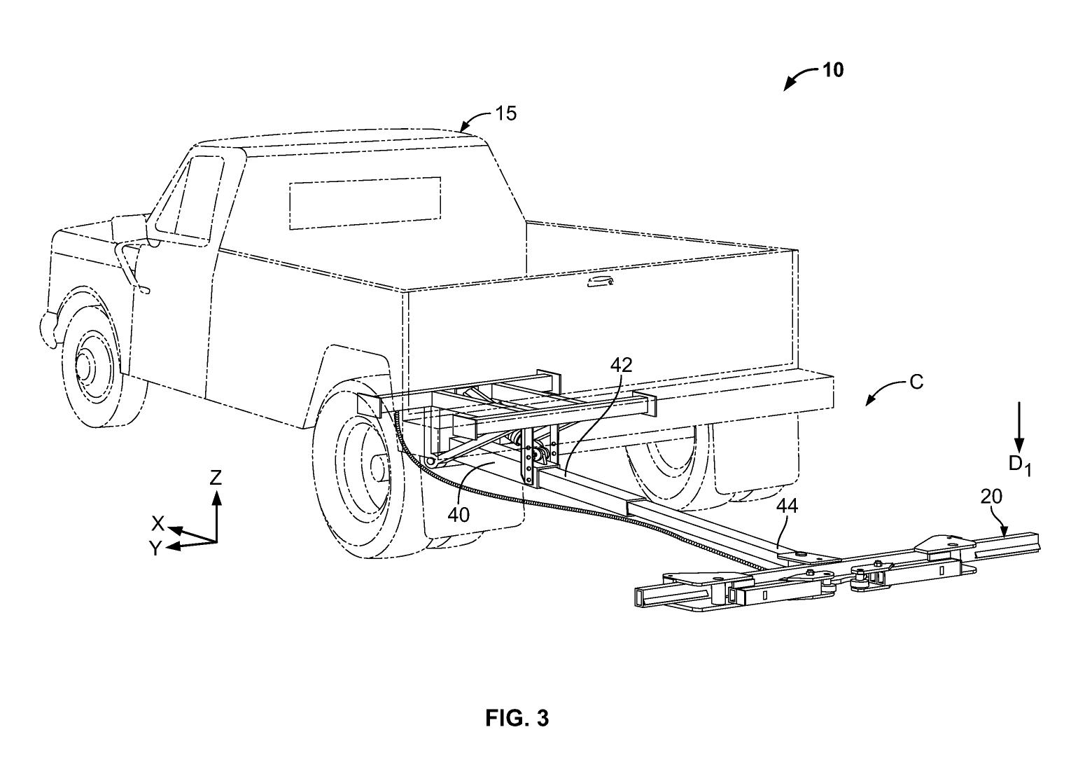

FIG. 3 shows the tow assembly 20 in a further partially deployed configuration C. As can be seen in FIG. 3, the tow assembly 20 has been further extended by fully extending the first and second boom extension members 44, 46, and lowering the wheel lift assembly 36 to be in contact with and to rest upon the ground. In an embodiment, the first and second boom extensions 44, 46 are extended up to 6 feet from the vehicle 15. In another embodiment, the first and second boom extensions 44, 46 are extended up to 65 inches from the vehicle 15. In yet another embodiment, the first and second boom extension members 44, 46 are extended up to 5 feet from the vehicle 15.

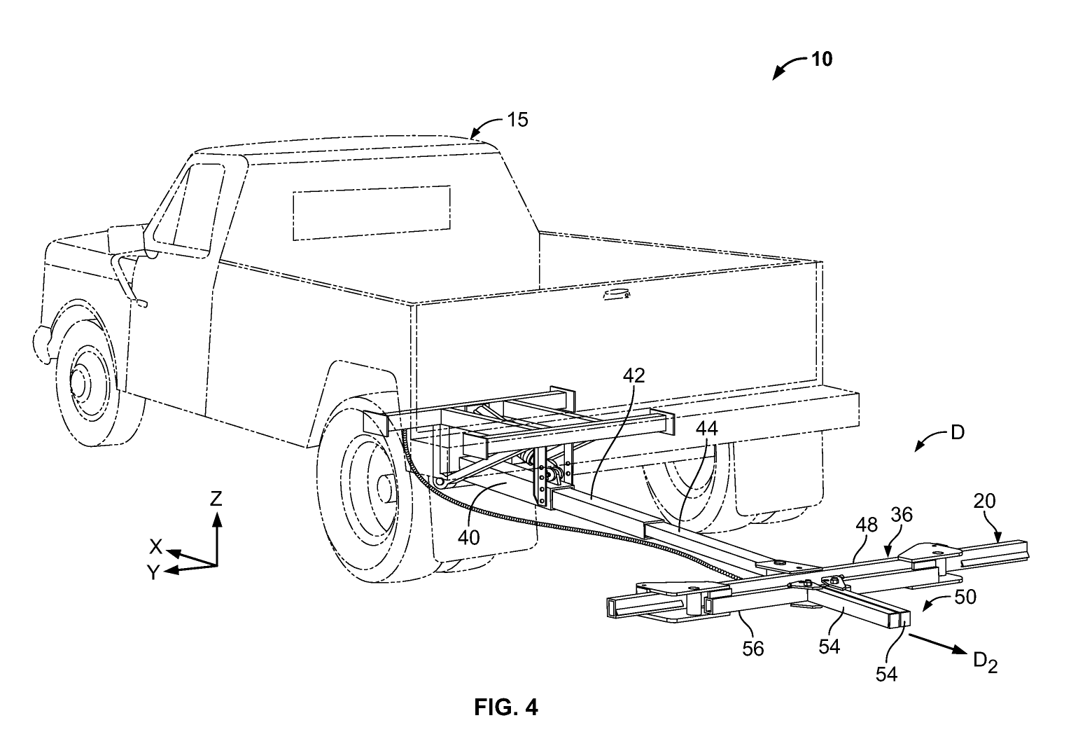

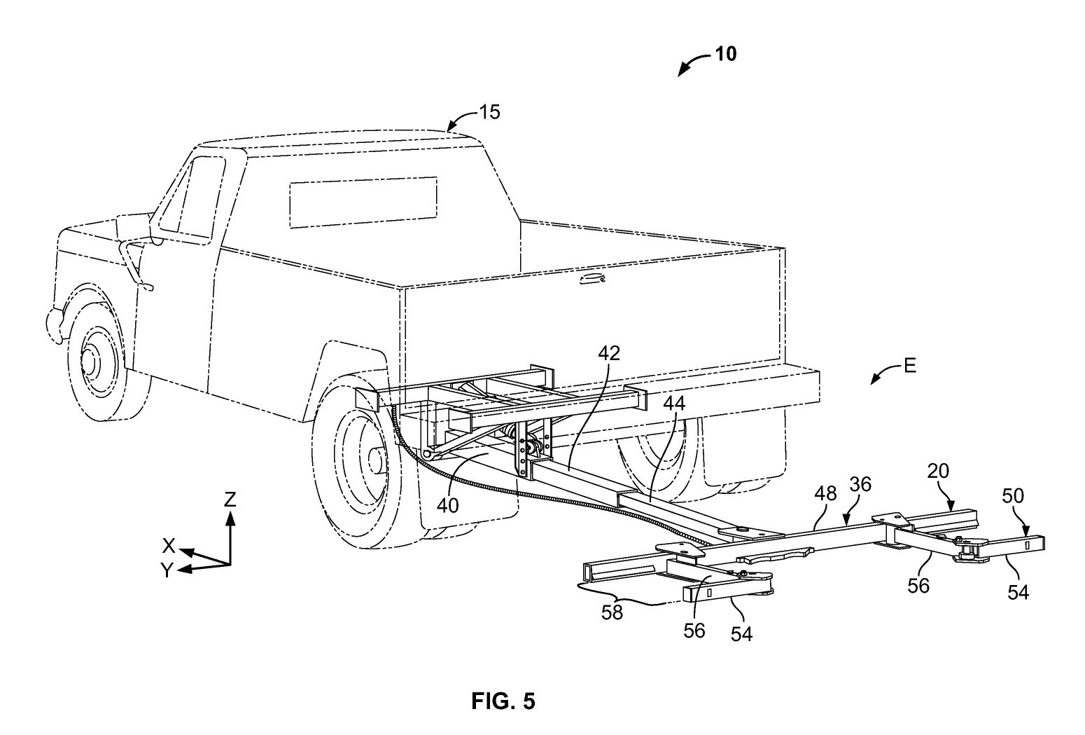

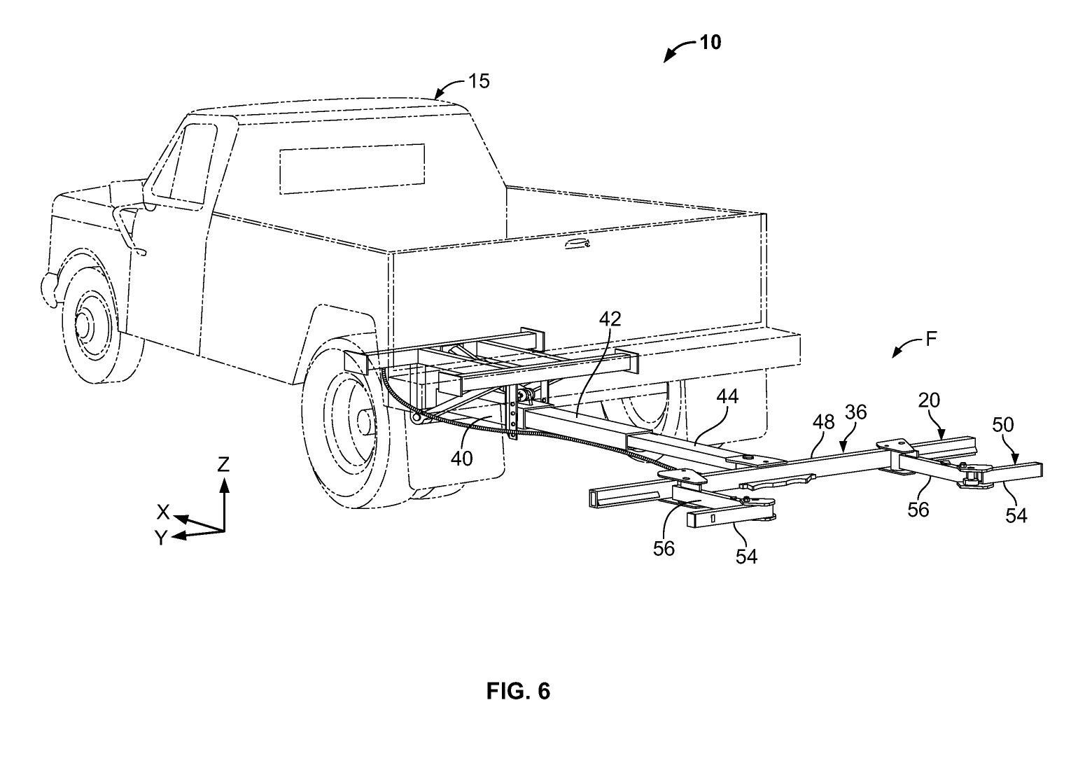

FIG. 4 shows the tow assembly 20 in a further partially deployed configuration D. As can be seen in FIG. 4, the wheel lift assembly 36 has been partially deployed by partially deploying the wheel support brackets 50. The wheel lift support brackets 50 are deployed by extending the rear wheel brace member 54. The rear wheel brace member 54 is extended by hydraulics (not shown).

In configuration D, the wheel lift assembly 36 is configured to be positioned under a second vehicle (not shown). The second vehicle is to be towed by the tow vehicle 10. To tow the second vehicle, the wheel lift assembly 36 is positioned under a second vehicle by moving the tow vehicle 10 in a rearward direction D₂ until the wheel lift base member 48 contacts or is proximate to wheels of the second vehicle that are to be engaged by the wheel lift assembly 36. As used herein, the term “proximate to” is defined as a distance wherein the rear wheel brace members 48 are capable of being positioned behind the wheels of the second vehicle.

FIG. 5 shows the tow assembly 20 in a deployed configuration E. As can be seen in FIG. 5, the wheel lift assembly 36 is fully deployed having the wheel extension members 54 fully extended from and substantially perpendicular to the wheel lift base member 48. As the wheel extension members 54 extend from wheel lift base member 48, the wheel extension members 54 are moved into a position substantially perpendicular to the wheel lift base member 48 and the wheel brace members 54 are moved into a position substantially perpendicular to the wheel extension members 54 and substantially parallel to the wheel lift base member 48. The wheel extension members 54 connect and are disposed between the wheel lift base member 48 and the wheel brace members 54

As can be seen in FIG. 5, the wheel lift base member 48 and the wheel brace members 54 define gaps 58 for receiving wheels of a vehicle to be towed (not shown). The wheel of the vehicle to be towed are in contact and supported by the lift base member 48 and the wheel brace members 54.

FIG. 6 shows the tow assembly 20 in a towing configuration F. As can be seen in FIG. 6, wheel lift assembly 36 has been raised by raising the boom housing 42 by the hydraulic assembly 32 (FIG. 2A). In such a manner, any wheels supported by the wheel lift assembly 36 are lifted or raised above the ground so that the tow vehicle may be towed.

The tow assembly 20 is retracted to the original stowed configuration shown in FIGS. 1 and 1A by reversing the deploying sequence described above. In particular, the tow assembly 20 is lowered to set the towed vehicle upon the ground, the wheel lift assembly 36 is retracted so that the wheel lift base and support members 48, 50 are retracted against the wheel lift base member 48, the first and second boom extension members 44, 46 are retracted into the boom housing 42 while the tow assembly 20 is raised by the hydraulic assembly 32 into the stowed configuration shown in FIGS. 1 and 1A. In another embodiment, the sequence of steps may be altered and/or combined to achieve the same result. For example, the first and second boom extension members 44, 46 members may be retracted and the tow assembly 20 raised during separate steps. In another embodiment, the first and second tow members 44, 46 may be simultaneously extended and retracted.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A tow assembly, comprising
a mounting frame; and
a wheel lift assembly;
wherein the wheel lift assembly comprises:
a boom assembly; and
a wheel lift assembly; and
wherein the wheel lift assembly is configured to be substantially concealed beneath a footprint of a tow vehicle to which the tow assembly is attached.

2. The tow assembly of claim 1, wherein the tow assembly is more than 95% concealed beneath the footprint of the tow vehicle.

3. The tow assembly of claim 1, wherein the tow assembly is more than 98% concealed beneath the footprint of the tow vehicle.

4. The tow assembly of claim 1, further comprising:
a hydraulic system for deploying and retracting the tow assembly; and
a control system for operating the hydraulic system.

5. The tow assembly of claim 1,
wherein the wheel lift assembly comprises:
a base member, extension members, and wheel brace members.

6. The tow assembly of claim 4, wherein the control system is a wireless control unit.

7. The tow assembly of claim 5, wherein the extension members and wheel brace members are extended by a hydraulic system to form a receiving gap with the base member to provide lift support for wheels of a towed vehicle.

8. A tow vehicle comprising:
a vehicle having a vertical footprint; and
tow assembly attached underneath the vehicle, the tow assembly comprising:
a mounting frame; and
a wheel lift assembly;
wherein the wheel lift assembly comprises:
a boom assembly; and
a wheel lift assembly; and
wherein the wheel lift assembly is configured to be substantially concealed beneath the vertical footprint of the vehicle.

9. The tow vehicle of claim 8, wherein the tow assembly is more than 95% concealed beneath the footprint of the tow vehicle.

10. The tow vehicle of claim 8, wherein the tow assembly is more than 98% concealed beneath the footprint of the tow vehicle

11. The tow vehicle of claim 8, further comprising:
a hydraulic system for deploying and retracting the tow assembly; and
a control system for operating the hydraulic system

12. The tow vehicle of claim 8, wherein the wheel lift assembly comprises:
a base member, extension members, and wheel brace members.

13. The tow vehicle of claim 11, wherein the control system is a wireless control unit.

14. The tow vehicle of claim 12, wherein the extension members and wheel brace members are extended by a hydraulic system to form a receiving gap with the base member to provide lift support for wheels of a towed vehicle

15. The tow vehicle of claim 8, wherein the vehicle is a pick-up truck.

16. A method of installing a tow assembly to a vehicle, comprising:
providing a vehicle having a vertical footprint; and
attaching a tow assembly underneath the vehicle;
wherein the tow assembly is more than 95% concealed beneath the footprint of the vehicle.

17. The method of claim 16, wherein the tow assembly is more than 95% concealed beneath the footprint of the vehicle

18. The method of claim 16, wherein the vehicle is a pick-up truck.
